(19) United States
(12) Patent Application Publication
(10) Pub. No.: US 2016/0073257 A1
(43) Pub. Date: Mar. 10, 2016

(54) Console Display Terminal

(71) Applicant: WEDOEY, INC., Spring Hill, FL (US)

(72) Inventor: Brandie Duncan, Cape Coral, FL (US)

(21) Appl. No.: 14/476,842

(22) Filed: Sep. 4, 2014

(51) Int. Cl. H04W 12/06; H04L 29/06; G10L 15/22; G06F 3/01; G06F 3/0484

(52) U.S. Cl. CPC H04W 12/06; G06F 3/017; G06F 3/04847; G06F 3/04842; G10L 15/22; H04L 63/04; H04L 63/08; G10L 2015/223

(57) ABSTRACT

The present invention comprises a console display terminal, comprising: a display screen configured to display a data item entered by a user, a transceiver configured to send and receive the data item to a network device, a sensing unit configured to detect and analyze an entry of the data item by the user, and a controller configured to verify the data item. The controller, upon detection and analysis of the data item, verifies the detected entry by evaluating the detected entry and identifying a display form for the data item. The controller further authorizes the display screen to display the data item in the determined display form in a list and authorizes the transceiver to send the data item to the network device. A system and a non-transitory computer readable storage medium having computer executable instructions are also provided to operate in conjunction with the console display terminal.

### FIELD OF THE INVENTION

The present invention relates to display devices.

### BACKGROUND OF THE INVENTION

A display device is an output device for presentation of information in visual or tactile form. When the input information is supplied as an electrical signal, the display is called an electronic display. Display devices act to show information in an easily readable and understandable method. Common applications for electronic visual displays are televisions, computer monitors and tactile electronic displays for blind people. Display devices may be used in a number of fields and vary in shape and size.

### SUMMARY OF THE INVENTION

It is, therefore, an object of the present invention to provide a console display terminal. It is another object of the present invention to provide a system of which said console display terminal is one component. Furthermore, a computer readable storage medium containing non-transitory computer executable instructions to operate said console display terminal as part of the said system is also provided.

An exemplary environment for the present invention can include, but is not limited to, use by an individual person, for example, a parent who places a grocery list and/or to-do list on the family refrigerator. The present invention is also contemplated to be used in any other environment in which display and interaction with a list is desired, for example, as part of business operation, under water as part of a diving procedure, or in a zoological or mammalian environment where listings of procedures and/or schedules are necessary.

In one exemplary embodiment of the present invention, a console display terminal is provided. Said console display terminal comprises a display screen, a transceiver, a sensing unit and a controller.

In one exemplary aspect of the present invention, the display screen is configured to display an at least one data item entered by a user. A data item can include, but is not limited to: a voice sound and/or spoken word or phrase; a written character and/or word or phrase; or a selection of a previously stored data spoken or written selection. Data items shall be discussed in more detail as part of the attached description.

In another exemplary aspect of the present invention, the transceiver is configured to send and receive the at least one data item to at least one network device. A network device can include, but is not limited to: a wireless routing device; a mobile device, such as a mobile phone or a tablet; or a remote server computing device. Network devices shall be discussed in more detail as part of the attached description.

In yet another exemplary aspect of the present invention, the sensing unit is configured to detect and analyze an entry of the at least one data item entered by the user.

In yet still another exemplary aspect of the present invention, the controller is configured to verify the detected entry of the at least one data item.

In further exemplary aspect of the present invention, the controller, upon detection and analysis of the at least one data item by the sensing unit, verifies the detected entry by evaluating the detected entry and identifying a display form for the at least one data item.

In yet a further exemplary aspect of the present invention, the controller can also authorize the display screen to display the at least one data item in the determined display form in a list and can also authorize the transceiver to send the at least one data item to the at least one network device.

The following are additional and/or exemplary aspects of the exemplary console display terminal as described above, one or more of which can be combined with the basic invention as embodied above:
an input surface further comprising a touch zone, the touch zone can be configured to capture at least one stroke made by the user on the input surface;
a stroke dictionary containing a plurality of characters stored based on shape and position;
a stroke recognizer configured to identify the at least one stroke as a character of the plurality of characters upon comparison to stroke dictionary storage;
an audio detector which can be configured to detect at least one audio tone created by a user;
a speech recognition dictionary containing a plurality of audio tones stored as at least one word based on a sound and a phonetic construction; and
a speech recognizer configured to identify the at least one audio tone as at least one work from the speech recognition dictionary;
identifying the display form by the controller can further comprise:
   determining an order of detection of the at least one data item;
   ordering the at least one data item according to a predetermined list feature based on the order of detection; and
   authorizing the display screen to display the at least one data item based on the predetermined list feature;
a predetermined list feature further comprises:
   a user option to select the parameters of the predetermined list feature; and
   a user option to create more than one predetermined list features;
a predetermined list feature further comprises:
   a memory for storing the at one or more predetermined list features; and
   a memory for storing the one or more display forms created based on user entry of the at least one data item;
the display screen further comprises a check box element which can be selected and de-selected based on the at least one data item displayed;
the transceiver is further configured to authenticate, send and receive the at least one data item between the display console device and a plurality of network devices; and
a replaceable independent power source.

One exemplary embodiment of the present invention further comprises a system, which comprises an intermediate computing device and a console display terminal.

In one exemplary aspect of the present embodiment, the intermediate computing device can be in communication via a network with one or more user devices and the console display terminal.

In another exemplary aspect of the present embodiment, the console display terminal can further comprise a processor that is configured to communicate with the intermediate computing device and the one or more client devices via the network.

In yet still another exemplary aspect of the present embodiment, the console display terminal can be further configured to perform actions.

In a further exemplary aspect of the present embodiment, the console display terminal can be configured to detect the at least one data item entered by a user.

In yet another exemplary aspect of the present embodiment, the console display terminal can be configured to verify and analyze the at least one data item entered by the user.

In still another exemplary aspect of the present embodiment, the console display terminal can be configured to identify a display form for the at least one data item.

In a further exemplary aspect of the present embodiment, the console display terminal can be configured to display the at least one data item in the determined display form in a list.

In still yet another exemplary aspect of the present embodiment, the console display terminal can be configured to configure the at least one data item such that it is transmittable to the intermediate computing device and the one or more user devices via the network.

In yet still a further exemplary aspect of the present embodiment, the console display terminal can be configured to send and receive the at least one data item to and from the intermediate computing device, the one or more user devices, and the console display terminal via the network.

The following are additional and/or exemplary aspects of the exemplary system as described above, one or more of which can be combined with the basic invention as embodied above:
detecting the at least one data item entered by a user further comprises:
   sensing at least one stroke made by the user on an input surface of the console display terminal;
   comparing the at least one stroke to a stroke dictionary containing a plurality of characters stored based on shape and position; and
   identifying the at least one stroke as a character of the plurality of characters upon comparison to the stroke dictionary;
detecting the at least one data item entered by a user further comprises:
   detecting at least one audio tone created by the user;
   comparing the at least one audio tone to a speech recognition dictionary containing a plurality of audio tones stored as at least one word based on a sound and a phonetic construction; and
   identifying the at least one audio tone as at least one word from the speech recognition dictionary;
configuring the at least one data item further comprises:
   configuring the at least one data item as one of a plurality of data items contained in the display form; and
   transmitting the at least one data item as one of a plurality of data items contained in the display form to and from the intermediate computing device, the one or more user devices, and the console display terminal via the network;
sending and receiving the at least one data item to and from the intermediate computing device, the one or more user devices, and the console display terminal via the network further comprises:
   a transceiver configured to communicate wirelessly using at least one radio frequency, said transceiver configured to send and receive the at least one data item according to IEEE 802.11 a, b, g, 2007, n, 2012, ac, ad, of and ah protocols and IEEE 802.15.1 protocols;
sending and receiving the at least one data item to and from the intermediate computing device, the one or more user devices, and the console display terminal via the network further comprises:
   a transceiver configured to communicate wirelessly using at least one infrared frequency, said transceiver configured to send and receive the at least one data item according to IrDA-SIR, IrDA-MIR, and IrDA-FIR protocols;
sending and receiving the at least one data item to and from the intermediate computing device, the one or more user devices, and the console display terminal via the network further comprises:
   a transceiver configured to authenticate wirelessly, comprising:
      encrypting the at least one data item when entered by the user; initiating wireless communication with a wireless communication device authenticating the wireless communication device using a private authentication key to authenticate the user's identity, identify the originating source of the at least one data item, and authenticate a stored data transmitted with the at least one data item; and
      sending the encrypted at least one data item upon positive authentication of the wireless communication device;
verifying and analyzing the at least one data item entered by the user further comprises comparing the entered at least one data item to a matrices of stored data libraries, wherein the matrices of stored data libraries further comprise audio tones and written stroke characters stored so that all information is accessible to the controller at such time that the user enters the at least one data item;
configuring the at least one data item such that it is transmittable to the intermediate computing device and the one or more user devices via the network further comprises storing the at least one data item to a memory in console display terminal; and
sending and receiving the at least one data item to and from the intermediate computing device, the one or more user devices, and the console display terminal via the network further comprises transmitting a communication with the transmitted at least one data item that is displayed on the one or more user devices as a coupon based on collected geographic data of the one or more user devices.

Another exemplary embodiment of the present invention comprises a non-transitory computer readable storage medium having computer executable instructions, the computer executable instructions when installed onto a computing device enable the computing device to perform actions.

In one exemplary aspect of the present embodiment, the computer executable instructions when installed onto a computing device can enable the computing device to detect an at least one data item entered by a user.

In another exemplary aspect of the present embodiment, the computer executable instructions when installed onto a computing device can enable the computing device to verify and analyze the at least one data item entered by the user.

In yet another exemplary aspect of the present embodiment, the computer executable instructions when installed onto a computing device can enable the computing device to identify a display form for the at least one data item.

In yet a further exemplary aspect of the present embodiment, the computer executable instructions when installed onto a computing device can enable the computing device to display the at least one data item in the determined display form in a list.

In yet still another exemplary aspect of the present embodiment, the computer executable instructions when installed onto a computing device can enable the computing device to configure the at least one data item such that it is transmittable to the intermediate computing device and the one or more user devices via the network.

In yet still a further exemplary aspect of the present embodiment, the computer executable instructions when installed onto a computing device can enable the computing device to send and receive the at least one data item to and from the intermediate computing device, the one or more user devices, and the console display terminal via the network.

The following are additional and/or exemplary aspects of the exemplary computer executable instructions as described above, one or more of which can be combined with the basic invention as embodied above:
the computer executable instructions enabling the computing device to perform actions, wherein detecting the at least one data item entered by a user further comprises:
   sensing at least one stroke made by the user on an input surface of the console display terminal;
   comparing the at least one stroke to a stroke dictionary containing a plurality of characters stored based on shape and position; and
   identifying the at least one stroke as a character of the plurality of characters upon comparison to the stroke dictionary;
the computer executable instructions enabling the computing device to perform actions, wherein detecting the at least one data item entered by a user further comprises:
   detecting at least one audio tone created by the user;
   comparing the at least one audio tone to a speech recognition dictionary containing a plurality of audio tones stored as at least one word based on a sound and a phonetic construction; and
   identifying the at least one audio tone as at least one word from the speech recognition dictionary;
the computer executable instructions enabling the computing device to perform actions, wherein configuring the at least one data item further comprises:
   configuring the at least one data item as one of a plurality of data items contained in the display form; and
   transmitting the at least one data item as one of a plurality of data items contained in the display form to and from the intermediate computing device, the one or more user devices, and the console display terminal via the network;
the computer executable instructions enabling the computing device to perform actions, wherein sending and receiving the at least one data item to and from the intermediate computing device, the one or more user devices, and the console display terminal via the network further comprises:
   a transceiver configured to communicate wirelessly using at least one radio frequency, said transceiver configured to send and receive the at least one data item according to IEEE 802.11 a, b, g, 2007, n, 2012, ac, ad, of and ah protocols and IEEE 802.15.1 protocols;
the computer executable instructions enabling the computing device to perform actions, wherein sending and receiving the at least one data item to and from the intermediate computing device, the one or more user devices, and the console display terminal via the network further comprises:
   a transceiver configured to communicate wirelessly using at least one infrared frequency, said transceiver configured to send and receive the at least one data item according to IrDA-SIR, IrDA-MIR, and IrDA-FIR protocols;
the computer executable instructions of Claim 20, enabling the computing device to perform actions, wherein sending and receiving the at least one data item to and from the intermediate computing device, the one or more user devices, and the console display terminal via the network further comprises:
a transceiver configured to authenticate wirelessly, comprising:
   encrypting the at least one data item when entered by the user;
   initiating wireless communication with a wireless communication device authenticating the wireless communication device using a private authentication key to authenticate the user's identity, identify the originating source of the at least one data item, and authenticate a stored data transmitted with the at least one data item; and
   sending the encrypted at least one data item upon positive authentication of the wireless communication device;
the computer executable instructions enabling the computing device to perform actions, wherein verifying and analyzing the at least one data item entered by the user further comprises comparing the entered at least one data item to a matrices of stored data libraries, wherein the matrices of stored data libraries further comprise audio tones and written stroke characters stored so that all information is accessible to the controller at such time that the user enters the at least one data item;
the computer executable instructions enabling the computing device to perform actions, wherein configuring the at least one data item such that it is transmittable to the intermediate computing device and the one or more user devices via the network further comprises storing the at least one data item to a memory in console display terminal; and
the computer executable instructions enabling the computing device to perform actions, wherein sending and receiving the at least one data item to and from the intermediate computing device, the one or more user devices, and the console display terminal via the network further comprises transmitting a communication with the transmitted at least one data item that is displayed on the one or more user devices as a coupon based on collected geographic data of the one or more user devices.

These and other exemplary aspects of the present invention are described herein.

Those skilled in the art will recognize still other aspects of the present invention upon reading and understanding the attached description.

### BRIEF DESCRIPTION OF THE DRAWINGS

The present invention is illustrated by way of example, and not in limitation, in the figures of the accompanying drawings.

FIG. 1 illustrates an exemplary embodiment of the present invention, more specifically, one exemplary front view of exterior features of a console display terminal.

FIG. 2 illustrates an exemplary embodiment of the present invention, more specifically, one exemplary embodiment of a console display terminal.

FIG. 2a illustrates an exemplary embodiment of one aspect of the present invention, more specifically, one exemplary embodiment of an audio tone sensing unit contained within a console display terminal.

FIG. 2b illustrates an exemplary aspect of the present invention, more specifically, one exemplary embodiment of a stroke recognition and/or sensing unit contained within a console display terminal.

FIG. 3 illustrates an exemplary embodiment of the present invention, more specifically, one exemplary embodiment of a system comprising a console display terminal and one or more network communication devices.

FIG. 4 illustrates an exemplary embodiment of the present invention, more specifically, one exemplary embodiment of a network communication device.

FIG. 5 illustrates an exemplary embodiment of the present invention, more specifically, one exemplary embodiment of a method of the computer executable instructions as stored in a non-transitory computer readable storage medium.

### DETAILED DESCRIPTION OF THE INVENTION

The present invention will now be described more fully herein after with reference to the accompanying drawings, which form a part hereof, and which show, by way of illustration, specific exemplary embodiments by which the invention may be practiced. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Among other things, the present invention may be embodied as methods or devices. Accordingly, various exemplary embodiments may take the form of an entirely hardware embodiments, an entirely software embodiment and/or an embodiment combining software and hardware aspects. The following detailed description is, therefore, not to be taken in a limiting sense.

Throughout the specification and claims, the following terms take the meanings explicitly associated herein, unless the context clearly otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. its purpose is merely to present some concepts in a simplified form as a prelude to the more detailed description that is presented later.

The present invention, generally, includes a device, system, and computer executable instructions for a mobile to-do list and/or grocery list console display terminal, which is in communication with a remote server and/or other network computing devices, so as the to-do list and/or grocery list can be synced and/or displayed on a number of devices at any time, once data is entered and a list is created.

The present invention generally includes a console display terminal or device which a user can enter data or information into, in a variety of methods, including but not limited to, verbalizing a word or phrase and the word or phrase spoken at the console display terminal, entering characters, word or phrases using a stylus or other apparatus, for example, a finger or nose. Once the data is entered into the console display terminal, the data is displayed as part of a list which has selectable check boxes and/or other methods of showing completion of an activity or purchase of a grocery item.

Furthermore, the created lists can be saved to the terminal display device and/or sent to a remote computing server for storage. The lists, also, can be transmitted to a number of wired, desktop, and/or mobile devices which contain an application and/or computer executable instructions which are recognized by the computing device for the purpose of displaying such lists. It is further contemplated that additional computer readable instructions, as part of the application and/or computer executable instructions would allow a remote user at the wired, desktop, and/or mobile devices to amend, revise, and/or otherwise change the synced list and transmit such amendments, revisions, and changes to the console display terminal, the remote computing server, and/or other network computing devices which contain an application and/or computer executable instructions which are recognized by the computing device for the purpose of displaying such lists.

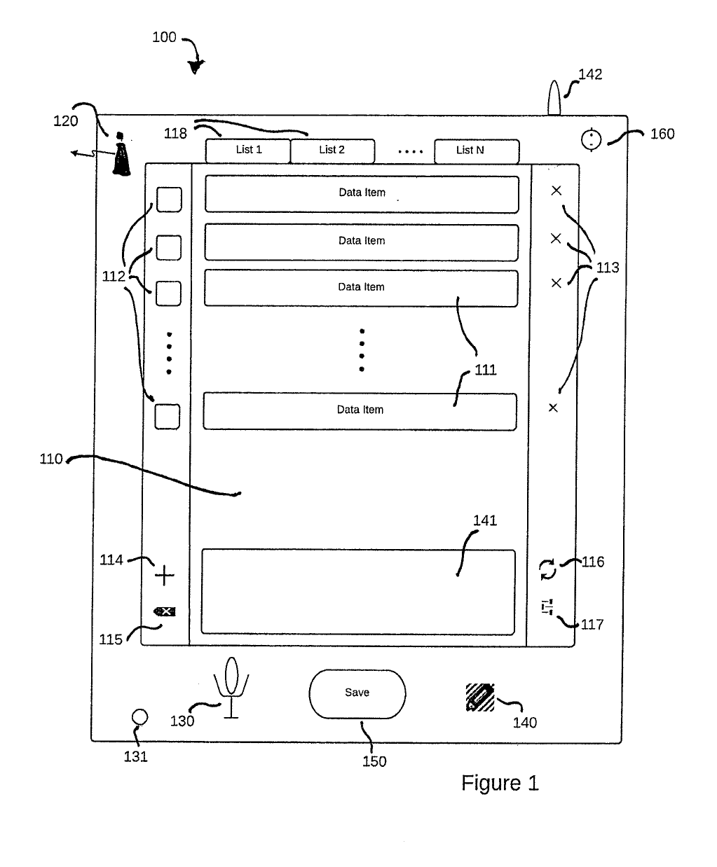

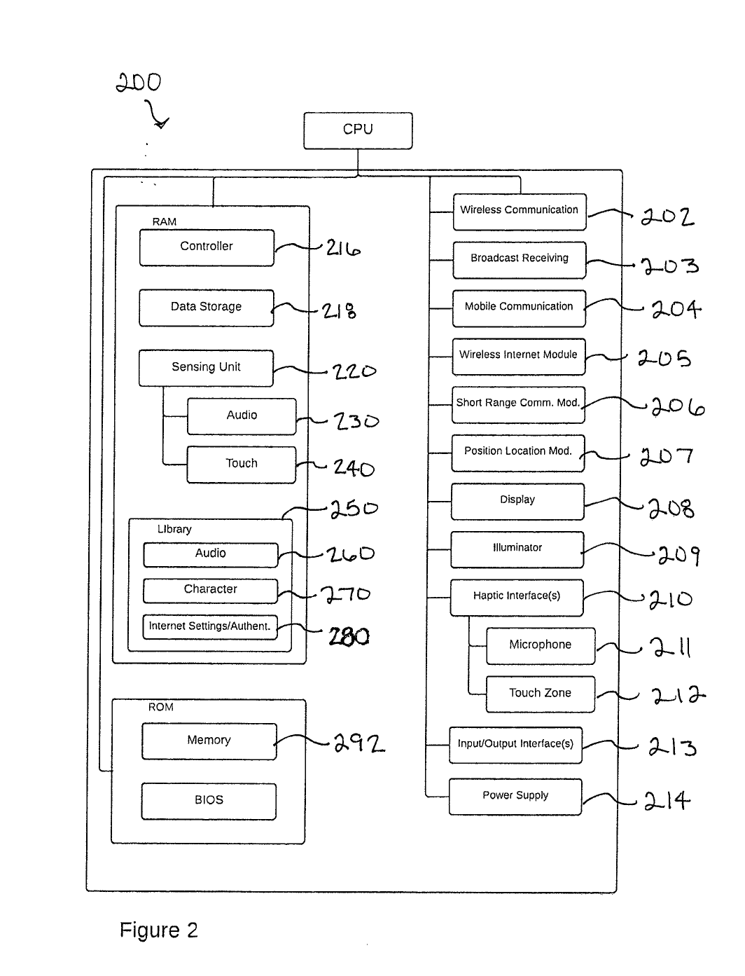

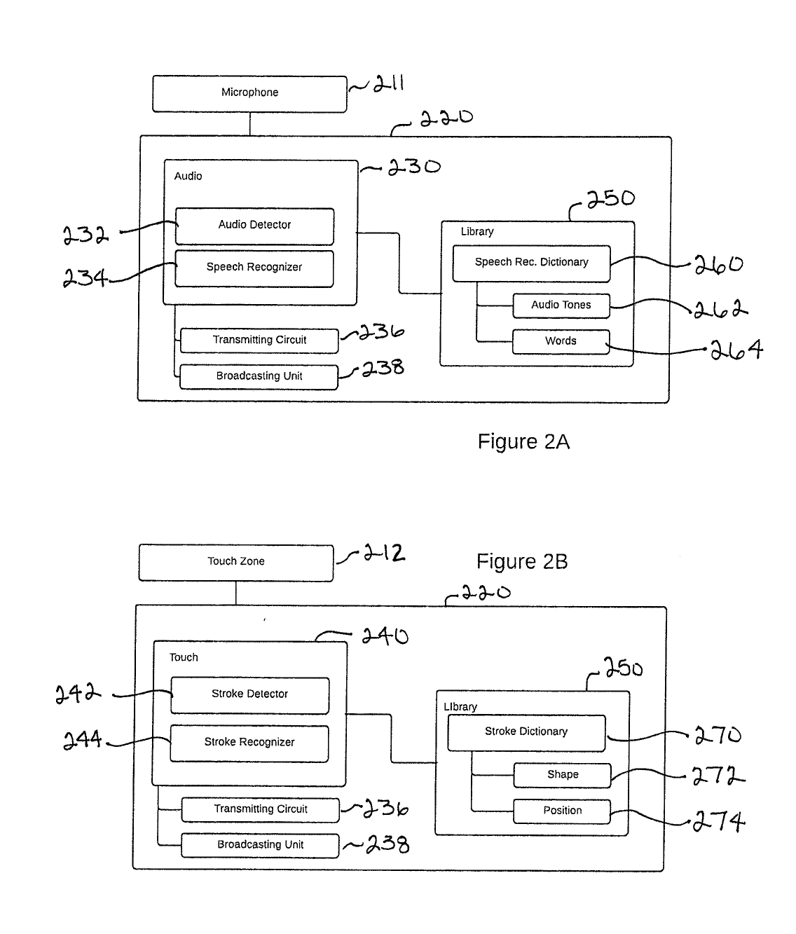

FIG. 1 illustrates a front perspective of a visual display and/or appearance of one embodiment of the present invention, a console display terminal 100. The console display terminal 100 comprises a display screen 110, a transceiver 120, an audio button 130, a touch screen activation button 140, a save button 150, and a power source 160. Additional functional elements, such as a sensing unit, a controller and a memory, of the console display terminal 100 shall be described in further detail below in reference to the block diagram illustrated in FIG. 2.

In FIG. 1, display screen 110 is configured to display a data item 111 when it is entered by a user. Display screen 110 may be a liquid crystal display (LCD), gas plasma, light emitting diode (LED), or any other type of display used with a computing and/or device with a display screen. Display screen 110 may also include a touch screen 141 arranged to receive input from an object such as a stylus 142 or a digit from a human hand, which will be discussed in more detail below.

Data item 111 can include but is not limited to a voice sound and/or spoken word or phrase, a written character and/or phrase, or a selection of a previously stored spoken or written selection. A data item 111, for example, can be one of a variety of consumer items such as groceries and other consumable products, for example, milk, cereal, personal hygiene supplies, and the like. A data item 111 may also include, for example, a to-be completed item, such as a to-do list or an organizational chart. Furthermore, any other functionally necessary data items for which a list configuration is method of displaying such can be entered. In FIG. 1, four data items 111 are illustrated by way of example. However, any number of data items 111 may be entered and/or stored by a user, for example, one, ten and twenty data items 111, or any other functionally necessary number of data items 111 can be entered.

Because of the quantity of data items 111 that can be entered, displayed, and/or stored using display screen 110, a number of lists 118 can be created and/or utilized as described in more detail below. Also, entry of data items 111 to the display screen 110 shall be discussed in more detail below.

Display screen 110 further includes check box elements 112, delete elements 113, and display screen settings elements 114-117. All of these elements as illustrated in FIG. 1 are for exemplary purposes only. One or more, or any combination including none of these elements can be used to operate the console display terminal 100. Therefore, one, any combination of, or none of these elements can be used when functionally necessary. Check box elements 112 as illustrated in FIG. 1 allow a user to place a check adjacent to a data item 111 displayed. A check box element 112 can appear adjacent to a data item 111 once a user enters the data item 111. A user can optionally change the appearance and/or display of a check box element 112 using the settings element 117 described in more detail below.

A check (not shown), as described herein, can have the purpose of signaling the completion of a to-do list item, for example, or may signify the purchase of a grocery item. In FIG. 1, four check box elements 12 are illustrated by way of example, to correspond with the illustrated exemplary data items 111. However, any number of check box elements 112 may be displayed, for example, one ten and twenty check box elements 112 to correspond to the data items 111 entered by a user. The appearance and/or use of a check may be optionally changed by a user using the settings element 117 described in more detail below. A check placed in check box element 112 may, for example, include the option to strike through the displayed data item 111 or provide the option to save 150 the data item 111. In an additional embodiment of the present invention, a check placed in check box element 112 may activate a setting 117 which allows a user to transfer a data item 111 to one or more lists 118 or create a new list 118 using the data item 111 as a title and/or element of said list 118.

Delete elements 113 can also be displayed adjacent to a data item 111 as illustrated in FIG. 1. A delete element 113 allows a user to remove an existing data item 111, change an existing data item, and/or any combination of removing and changing as deemed functionally necessary by a user. For example, in one embodiment, a user may determine that one data item is spelled incorrectly and selecting delete element 113 displays a list of different spellings for the entered data item 111. In another exemplary embodiment, delete element 113 provides a display option to remove a single data item 111, a list of selectable data items 111, and or one or more lists 118.

In an additional embodiment of the present invention, a user selecting a delete element 113 may also activate a setting 117 which allows a user to transfer a data item 111 to one or more lists 118 or create a new list 118 using the data item 111 as a title and/or element of said list 118.

Add element 114 allows a user to add a data item 111 or list 118 to the display screen 110. Subtract element 115 allows a user to remove a data item 111 or list 118 from the display screen 110. Elements 114, 115 may have similar functionality to check box elements 112 and delete elements 113 as described above while also providing a user with the option for different functionalities and ease of use.

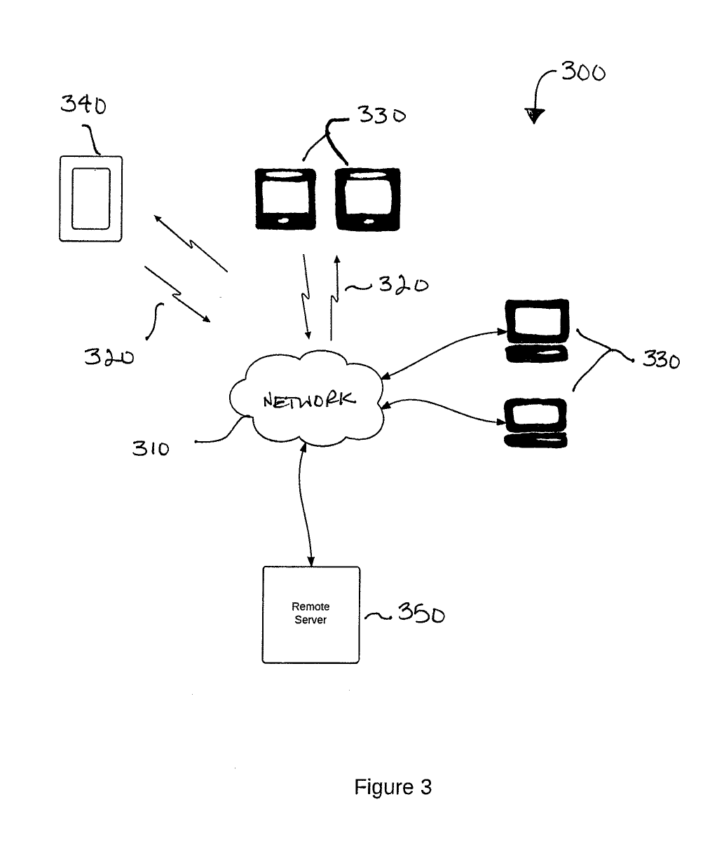

Refresh element 116 allows a user to refresh and/or sync data items 111 and/or lists 118 via transceiver 120 as described below, and in further detail in reference to FIGS. 2-3.

List element 118 provides a user a platform for entering one or more than one data item 111 in a variety of formats. List element 118 allows a user to categorize data items 111, for example, into lists of a voice sound and/or spoken word or phrase, a written character and/or phrase, or a selection of a previously stored spoken or written selection. A list element can further include, for example, a variety of consumer items such as groceries and other consumable products, for example, milk, cereal, personal hygiene supplies, and the like. A list element 118 may also include, for example, a to-be completed item, such as a to-do list or an organizational chart. List elements 118 can be stored, for example, in a memory (not shown), or sent to one or more network devices (not shown) via transceiver 120.

Transceiver 120 includes circuitry for console display terminal 100 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internetprotocol (TCP/IP), SMS, general packet radio service (GPRS), WAP, ultra wide band (UEB), IEEE 8022.16 Worldwide Interoperability for Microwave Access (WiMax), SIP/RTP, or any of a variety of other wireless communication protocols.

Transceiver 120 may also be configured to communicate wirelessly using at least one radio frequency, and/or to send and receive the at least one data item 111, for example, according to IEEE 802.11 a, b, g, 2007, n, 2012, ac, ad, of and ah protocols and IEEE 802.15.1 protocols. In one embodiment of the present invention, sending and receiving a data item 110 may include transceiver 120 being configured to communicate wirelessly using at least one infrared frequency, said transceiver configured to send and receive the at least one data item according to IrDA-SIR, IrDA-MIR, and IrDA-FIR protocols.

In additional embodiments of the present invention may include a transceiver 120 configured to authenticate wirelessly. This authentication may include encrypting a data item 110 when entered by the user, initiating wireless communication with a wireless communication device authenticating the wireless communication device using a private authentication key to authenticate the user's identity, identify the originating source of the one data item, further authenticating a stored data key transmitted with the data item 111 and sending the encrypted at data item 111 upon positive authentication of the wireless communication device. Authentication and user devices shall be described in more detail below.

Display console terminal 100 illustrated in FIG. 1 further includes an audio button 130 and a microphone 131. A user can optionally use audio tones to enter a data item 111, by activating audio button 130. Activation of audio button 130 can occur through any method of activation that is functionally compatible with manufacturing methods, for example, depression of a toggle or bezel button, a touch screen as described above, or receiving an audio activation tone. A sensing unit (not shown), which shall be described in more detail in FIG. 2, can receive audio tones via microphone 131.

Microphone 131 is illustrated as being located on the face of console display terminal 100 adjacent to audio button 130. However, microphone 131 can be any of a transducive element contained within the console display terminal 100 housing, for example, a receiver or resonator that is selectively optionally tunable and extends fully or partially through the console display terminal 100 housing. Transmission of an audio tone through microphone 131 and analysis by the sensing unit shall be discussed in more detail in FIG. 2a.

Touch screen activation button 140 as illustrated allows a user the option of a text entry mode by activating a touch screen 141. A user can optionally use strokes created by a pointing element, such as a finger or stylus 142, to enter a data item 111 in the touch screen 141 area. Activation of touch screen activation button 140 can occur through any method of activation that is functionally compatible with manufacturing methods, for example, depression of a toggle or bezel button, or as part of and/or separate from and independently a touch screen as described above.

Touch screen 141 may include an input surface for capturing and/or recording strokes. The input surface is illustrated in FIG. 1 as being a portion of the console display screen 110, however it may be, for example, an input pad, a touch panel, a touch screen, such as a liquid crystal display (LCD) screen with an integrated touchpad, a multifunctional touch button, a multifunctional push button, a scroll wheel or a click wheel, or a selection device based on a combination of a button and a scroll or click wheel, an optical coordinate input detection device, or a surface having one or more optical sensors, for example, a complementary metal oxide semiconductor (CMOS)-based or charge coupled device (CCD) based sensors, or any other functionally necessary and compatible element for capturing strokes which are performed by a pointing element. The touch screen may be connected to an encoding element (not shown) which may encode the shape of the stroke and the relative position of the stroke in relation to the touch screen. Recognition in this manner shall be described in more detail in FIG. 2b.

Stylus 142 can be any functionally necessary and/or compatible pointing element which may produce a stroke on touch screen 141. It should be noted that a pointing element such as stylus 141 need not be used, a human user may use an appendage such as a finger to make a stroke which can be recognized on the touch screen 141. In further embodiments, a touch screen 141 may also be configured to allow a mammal, such as a pet dog, cat or another mammalian animal kept in a zoo or research facility, to make strokes which can be recognized using appendages such as, for example, a paw, a nose, a flipper or toes. In these types of embodiments, the touch screen may display, for example, a series of images, one of which may be selected. Additional embodiments may include a sensor for specific entry of a known data item when any type of touch to the screen is sensed.

Data items 111 then displayed on the display screen 110 after being entered by a user using microphone 131 and/or touch screen 141 can be displayed in a variety of formats. For example, the data item 111 can be displayed in the strokes made by the user, i.e., in the user's own handwriting. In another example, the data item 111 can be displayed in a digitized font, in the user's own tones, in a digitized tone or any other display method that is reasonably functional to the operation of the console display unit 100. In further embodiments where the touch screen 141 is configured to allow for animal use, the data items 111 may be, for example, displayed as images of other functionally compatible symbols.

Display console terminal 100 illustrated in FIG. 1 further includes an save button 150. A user has the option to save a single data item 111, a list 118, or any combination thereof by activating the save button 150. Activation of save button 150 can occur through any method of activation that is functionally compatible with manufacturing methods, for example, depression of a toggle or bezel button, a touch screen as described above, or receiving an audio activation tone. Saved information is generally retained in a memory (not shown), which is described in more detail in FIG. 2.

FIG. 1 also includes a power source 160. A power supply is commonly a device that supplies electric power to an electrical load. The term is most commonly applied to electric power converters that convert one form of electrical energy to another, though it may also refer to devices that convert another form of energy, for example, mechanical, chemical, solar, to electrical energy. A regulated power supply can be defined as a power supply that controls the output voltage or current to a specific value; the controlled value is held nearly constant despite variations in either load current or the voltage supplied by the power supply's energy source. A power supply may obtain the energy it supplies to its load, as well as any energy it consumes while performing that task, from an energy source. Depending on its design, a power supply may, for example, obtain energy from an electrical energy transmission systems. Common examples of this include power supplies that convert AC line voltage to DC voltage; energy storage devices such as batteries and fuel cell; electromechanical systems such as generators and alternators and solar power.

Power source 160 may be implemented as a discrete, stand-alone device or as an integral device that is hardwired to console display terminal 100. Examples of the latter case include the low voltage DC power supplies that are part of desktop computers and consumer electronics devices. Commonly specified power supply attributes include the amount of voltage and current it can supply to its load, how stable its output voltage or current is under varying line and load conditions, and how long it can supply energy without refueling or recharging (applies to power supplies that employ portable energy sources). Power source 160 may be integrated, attached to or separating providing electric power to console display unit 100 in any of the methods described above, or created according to any functionally necessary and/or compatible manufacturing processes.

FIG. 2 is a block diagram illustrating one exemplary embodiment of a console display terminal 200. Console display terminal 200 can include a number of components as described in further detail below. All the various components as described herein are not required and/or can be combined in various configurations not shown, to further implement console display terminal 200. Greater or fewer components may alternatively be implemented.

In FIG. 2, wireless communication unit 202 typically includes one or more components which permits wireless communication between the console display terminal 200 and a wireless communication system or network within which the console display terminal 200 is located. For instance, the wireless communication unit 202 can include a broadcast receiving module 203, a mobile communication module 204, a wireless internet module 205, a short-range communication module 206, a position-location module 207 and the like.

The broadcast receiving module 203 receives a broadcast signal and/or broadcast associated information from an external broadcast managing server via a broadcast channel. The broadcast channel may include, for example, a satellite channel and a terrestrial channel. The broadcast managing server generally refers to a server which generates and transmits a broadcast signal and/or broadcast associated information or a server which is provided with a previously generated broadcast signal and/or broadcast associated information and then transmits the provided signal or information to a terminal. Embodiments of the present invention which include such broadcast receiving module 203 are contemplated for use in various environments. For example, one embodiment is contemplated where console display terminal 200 is used in an aquatic setting as a checklist device for divers, researchers and others in a marine environment where traditional radio and wireless internet signals are not functional.

The broadcast signal may be implemented in a variety of manners, including, but not limited one or more of the following exemplary methods: as a TV broadcast signal, a radio broadcast signal, and a data broadcast signal, among others. If desired, the broadcast signal may further include a broadcast signal combined with a TV or radio broadcast signal. The broadcast associated information can include, for example, information associated with a broadcast channel, a broadcast program, a broadcast service provider, etc. Furthermore, the broadcast associated information may be provided via a mobile communication network. In this exemplary embodiment, the broadcast associated information can be received by the mobile communication module 204.

The broadcast associated information can be implemented in various forms. In one example, broadcast associated information may include an electronic program guide (EPG) of digital multimedia broadcasting (DMB) and electronic service guide (ESG) of digital video broadcast-handheld (DVB-H).

The broadcast receiving module 203 may be configured to receive broadcast signals transmitted from various types of broadcast systems. By non-limiting example, such broadcasting systems include digital multimedia broadcasting-terrestrial (DMB-T), digital multimedia broadcasting-satellite (DMB-S), digital video broadcast-handheld (DVB-H), DVB-CBMS, OMA-BCAST, the data broadcasting system known as media forward link only (MediaFLO®) and integrated services digital broadcast-terrestrial (ISDB-T). Optionally, the broadcast receiving module 203 can be suitably configured for other broadcasting systems as well as the above-explained digital broadcasting systems. The broadcast signal and/or broadcast associated information received by the broadcast receiving module 203 may be stored in a suitable device, such as memory 292.

The mobile communication module 204 transmits and/or receives wireless signals to and/or from one or more network entities (e.g., base station, external terminal, server, etc.). Such wireless signals may represent, for example, audio and data according to text/multimedia message transceivings, among others.

The wireless internet module 205 supports Internet access for the console display terminal 200. This module may be internally or externally coupled to the console display terminal 200. In this exemplary case, the wireless internet technology can include WLAN (Wireless LAN) (Wi-Fi), Wibro (Wireless broadband), Wimax (World Interoperability for Microwave Access), HSDPA (High Speed Downlink Packet Access) or any other functionally compatible wireless internet technology.

The short-range communication module 206 facilitates relatively short-range communications. Suitable technologies for implementing this module include radio frequency identification (RFID), infrared data association (IrDA), ultrawideband (UWB), near frequency communication (NFC), as well as the networking technologies commonly referred to as Bluetooth and ZigBee, to name a few exemplary technologies. Additional short-range communication technologies are contemplated in further embodiments of the present invention.

The position-location module 207 identifies or otherwise obtains the location of the mobile terminal 200. If desired, this module may be implemented with a global positioning system (GPS) module.

FIG. 2 further illustrates the exemplary aspect of display 208. Display 208, for example, is typically implemented to visually display (output) information associated with the console display terminal 200. Display 208 may be implemented using known display technologies including, for example, a liquid crystal display (LCD), a thin film transistor-liquid crystal display (TFT-LCD), an organic light-emitting diode display (OLED), a flexible display and a three-dimensional display. It is further contemplated that in additional embodiments of the present invention, console display terminal 200 may include one or more of such displays.

In further additional embodiments, one or more of the displays can have a transparent or light-transmitting configuration to be externally viewable there through. And, such a display can be called a light-transmitting display. TOLED (transparent OLED), AMOLED (active matrix OLED) and the like are representative examples of the light-transmitting displays. And, a rear structure of the display can have the light-transmitting configuration as well. According to this configuration, a user is able to see an object located behind the terminal body through the region occupied by display 208 of the terminal body.

In a case that the display 208 and a sensor for detecting a touch action (hereinafter called ‘touch zone 212’) of such a pointer as a user's finger, a stylus, a pen and the like configures a mutual layer structure (hereinafter called ‘touchscreen’ not shown), it is able to use display 208 as an input device as well as an output device. In this case, touch zone 212 can be configured with a touch film, a touch sheet, a touchpad or the like for example.

Display 208, as further illustrated in FIG. 2, can include an illuminator 209 element which can, for example, provide backlighting, front-lighting or any other functionally compatible form of illumination for display 208.

FIG. 2 further illustrates haptic interface 210, which may, for example, receive and generate various tactile effects that can be viewed and/or sensed by a user. Vibration is a representative one of the tactile effects generated by the haptic interface 210, and, in a further example, microphone 211 of haptic interface 210 can receive a sound generated by a user. Strength and pattern of the vibration generated and/or received by the haptic interface 210 may be controllable in exemplary embodiments of the present invention. For instance, different tones can be input in a manner of being synthesized together or can be outputted in sequence.

Microphone 211 of haptic interface 210 receives an external audio signal while the console display terminal 200 is in a particular mode, for example, when the microphone button is depressed and voice recognition is triggered, as described in more detail in reference to FIG. 1. This audio signal is processed and converted into electric audio data and analyzed by the audio 230 portion of sensing unit 220, described in more detail with reference to FIG. 2A. The processed audio data can be transformed into a format transmittable to a mobile communication base station via the mobile communication nodule 204 or can be transformed by an audio element 230 of sensing unit 220 to a format suitable for visual display. Controller 216 can thereby, in one exemplary embodiment, be transferred the formatted audio communication, so as to properly display the date on display 208. Microphone 211 can typically include, for example, assorted noise removing algorithms to remove noise generated in the course of receiving the external audio signal.

Touch zone 212 of haptic interface 210 can be configured to convert a pressure applied to a specific portion of display 208 or a variation of a capacitance generated from a specific portion of display 208 to an electric input signal. Moreover, touch zone 212 can also to be able configured to detect a pressure of a touch as well as a touched position or size.

In one exemplary embodiment of the present invention, if a touch is made to touch zone 212, signal(s) corresponding to the touch can be transferred to a touch element 240 of a sensing unit 220. This touch element 240 can further process the signal(s) and then transfer the processed signal(s) to the controller 216. Therefore, controller 216 is able to know which portion of display 208 is touched.

The input/output interfaces 213 illustrated in FIG. 2 play a role as an interface with every external device which can be connected to console display terminal 200. For instance, the external devices may include, for example, a wire/wireless headset, an external electricity charger, a wire/wireless data port, a card socket (e.g., memory card socket, SIM/UIM card port, a card socket, etc.), audio I/O (input/output) terminals, video I/O (input/output) terminals, earphones, etc. In further contemplated exemplary embodiments, input/output interfaces 213 receive data from the external device(s) or are supplied with power. Input/output interfaces 213 then deliver the received data or the supplied power to the corresponding component within the console display terminal 200 or transmit data within the terminal 200 to the corresponding external device.

In one exemplary embodiment, where the console display terminal 200 is connected to an external cradle (not shown), input/output interfaces 213 becomes a passage for supplying the console display terminal 200 with a power from the cradle or a passage for delivering various command signals inputted from the cradle by a user to the console display terminal 200. Each of the various command signals inputted from the cradle or the power may operate as a signal enabling the console display terminal 200 to recognize that it is correctly loaded in the cradle.

The power supply 214 receives an external and/or internal power source and then supplies power required for operations of the respective components, under the control of the controller 216.

Controller 216 as illustrated in FIG. 2 may, for example, control overall operations of console display terminal 200. For instance, controller 216 performs the control and processing related to audio recognition, data communication, touch recognition and the like. Controller 216 can be provided with any number of modules, for example, sensing unit 220, library 250 or modules not illustrated, for example a multimedia module for multimedia playback such as chime or notification alarm. These exemplary modules can be configured as hardware within controller 216 or software separate from controller 216.

Controller 216 is able to perform a tone recognizing processing for recognizing audio tone input performed by a user, which shall be discussed in more detail with reference to FIG. 2A. Controller 216 is also able to perform a pattern recognizing processing for recognizing a handwriting input or a drawing input performed on the touchscreen into a character and an image, respectively, which shall be discussed in more detail with reference to FIG. 2B.

The data storage module 218 can store various kinds of information, for example, for authenticating a use authority of the console display terminal 200 and can include User Identity Module (UIM), Subscriber Identity Module (SIM), Universal Subscriber Identity Module (USIM) and/or the like.

Sensing unit 220 can be provided to an internal area of the console display terminal 200, for example, enclosed by the touchscreen or near a toggle button as described in more detail in reference to FIG. 1. Audio element 230 of sensing unit 220 can have a number of operations, for example, a recording mode, a voice recognition mode, a broadcast reception mode and the like to receive audio data which is received from a user, the wireless communication unit 202, or is stored in the memory 2292. During operation, the audio element 230 receives audio relating to a particular function (e.g. user input, a stored data item, a transmitted data signal, etc.). The audio element 230 is often implemented using one or more or microphone 211 or other haptic input and/or audio receiving devices, and combinations thereof.

The touch element 240 of sensing unit 220 may be the sensor that detects a presence or non-presence of an object approaching the touch zone 212 or an object existing around sensing unit 220 using an electromagnetic field strength or infrared ray without mechanical contact. Hence, the sensing unit 220 has durability longer than that of a contact type sensor and also has utility wider than that of the contact type sensor.

Touch element 240 of sensing unit 220 can include, for example, one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that touch zone 212 includes the electrostatic capacity proximity sensor, it is configured to detect the proximity of a pointer using a variation of electric field according to the proximity of the pointer. In this case, the touch zone 212 (touch sensory can be classified as the sensing unit 220).

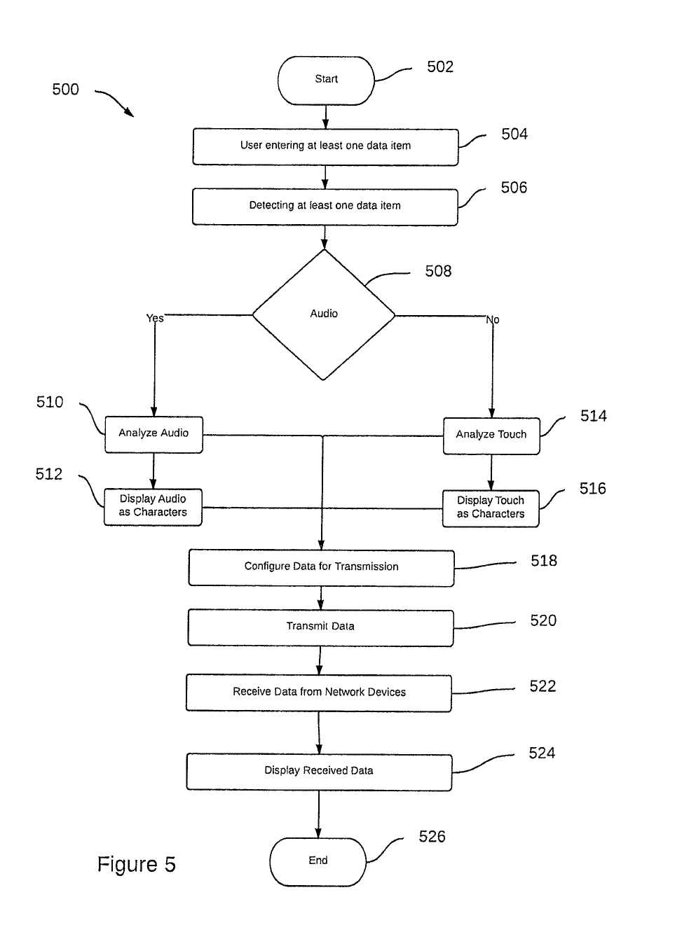

Sensing unit 220 works in conjunction with library 250 elements, as voice recognition and touch recognition of data items require cross-reference with catalogued stored data. For example, FIG. 2 illustrates library 250 as containing an audio 260 library element, a character 270 library element, and an internet settings/authentication 280 library element. Audio 260 library element shall be described in more detail with reference to FIG. 2A. Character 270 library element shall be described in more detail with reference to FIG. 2B. Internet settings/authentication 280 library element shall be described in more detail with reference to FIG. 5.

Memory 292 can store programs for the processing and control of controller 216 and is able to perform a function for temporary storage of inputted/outputted data (e.g., stored lists, data sync information, text data, audio data, etc.). Moreover, memory 292 can store data of various patterns of sound outputted in case of the touch input to the touchscreen. Memory 292 may include at least one storage medium of such a type as a flash memory type, a hard disk type, a multimedia card micro type, a card type memory (e.g., SD memory, XD memory, etc.), RAM SRAM (Static Random Access Memory), ROM, EEPROM (Electrically Erasable Programmable Read-Only Memory) and the like. Moreover, console display terminal 200 is able to operate a web storage that performs a storage function of the memory 292 via the internet.

Various embodiments described herein may be implemented in a computer-readable medium using, for example, computer software, hardware, or some combination thereof.

For a hardware implementation, the embodiments described herein may be implemented within one or more application specific integrated circuits (ASIGs), digital signal processors (DPs), digital signal processing devices (DSPDs), programmable logic devices (PLD's), field programmable gate arrays (FPGAs), processors, controllers, micro-controllers, microprocessors, other electronic units designed to perform the functions described herein, or a selective combination thereof. Such embodiments may also be implemented by the controller 280.

For a software implementation, the embodiments described herein may be implemented with separate software modules, such as procedures and functions, each of which perform one or more of the functions and operations described herein. The software codes can be implemented with a software application written in any suitable programming language and may be stored in the memory 292, and executed by the controller 216.

FIG. 2A illustrates one exemplary embodiment of audio 230 element of sensing unit 220. Generally, audio 230 element may be a module which has many similar qualities to a sound recording and/or reproduction device. For example, these devices may create an electrical or mechanical inscription and re-creation of sound waves, such as spoken voice, singing, instrumental music, or sound effects. The two main classes of sound recording technology are analog recording and digital recording. Historically, acoustic analog recording was achieved by a small microphone diaphragm that detected changes in atmospheric pressure, which may also be defined as acoustic sound waves, and recorded them as a graphic representation of the sound waves on a medium such as a phonograph, in which a stylus senses grooves on a record. Also, in magnetic tape recording, the sound waves vibrated the microphone diaphragm and were converted into a varying electric current, which then could be converted to a varying magnetic field by an electromagnet which made a representation of the sound as magnetized areas on a plastic tape with a magnetic coating on it. Analog sound reproduction is the reverse process, with a bigger loudspeaker diaphragm causing changes to atmospheric pressure to form acoustic sound waves.

Digital recording and reproduction converts the analog sound signal picked up by the microphone to a digital form by a process of digitization, allowing it to be stored and transmitted by a wider variety of media. Digital recording stores audio as a series of binary numbers representing samples of the amplitude of the audio signal at equal time intervals, at a sample rate high enough to convey all sounds capable of being heard. Digital recordings are considered higher quality than analog recordings not necessarily because they have higher fidelity (wider frequency response or dynamic range), but because the digital format can prevent much loss of quality found in analog recording due to noise and electromagnetic interference in playback, and mechanical deterioration or damage to the storage medium.

As such, microphone 211 may operate in conjunction with sensing unit 220 to receive at least one element of sound or audio data, using one of the methods described in the preceding paragraphs, or using any reasonably known audio collection method or any method which is unknown by reasonably ascertainable.

Audio 230 element of sensing unit 220 can further comprise audio detector 232, speech recognizer 234. Sensing unit 220 may further comprise a transmitting circuit 236 and broadcasting unit 238, which can additionally allow for sending and/or receiving audio data to and from sensing unit 220. Audio detector 232 may be, for example, any detecting and/or sensing element which is functionally compatible or necessary for satisfactory operation as a detecting element. Examples include, but are not limited to a transducer, a general microphone, a geophone, a hydrophone, lace sensor or other type of audio or sound sensing component.

Speech recognizer 234, likewise may optionally be an audio and/or sound recognizing and sensing component, however, speech recognizer 234 narrows the type of sensing and/or recognition to a specific set of tones and sounds which are common to a human or other mammalian sound, for example, a human voice and a dog bark. Furthermore, speech recognizer 234 operates in conjunction (as described below) with library 250 and transmitting circuit 236 and broadcasting unit 238 to transmit the recognized sounds into written language and or text to be displayed on a display component (as described in reference to FIGS. 1 and 2), as described above. In computer science and electrical engineering, speech recognition (SR) is the translation of spoken words into text. It is also known as “automatic speech recognition” (ASR), “computer speech recognition”, or just “speech to text” (STT).

An SR system, such as, for example, speech recognizer 234, may use “speaker-independent speech recognition, or in another embodiment may use “training” where an individual speaker reads sections of text into the SR system. These systems, for example, analyze the person's specific voice and use it to fine-tune the recognition of that person's speech, resulting in more accurate transcription. Systems that do not use training are called “speaker-independent” systems. Systems that use training are called “speaker-dependent” systems.

Additional speech recognizer 234 embodiments may include voice user interfaces such as voice dialing, call routing, domotic appliance control, search, simple data entry, preparation of structured documents, speech-to-text processing, and aircraft more commonly termed direct voice input. The term voice recognition or speaker identification refers to finding the identity of “who” is speaking, rather than what they are saying. Speech recognizer 234, in further embodiments, may optionally recognize a speaker, for example, determine a speaker and add data elements to a specific list (as described above with reference to FIG. 1), so as to simplify the task of translating speech in systems that have been trained on a specific person's voice or it can be used to authenticate or verify the identity of a speaker as part of a security process.

Audio 230 element of sensing unit 220 additionally can be in communication with library 250, more specifically speech recognition dictionary 260 which can optionally further comprise audio tones 262 and words 264.

FIG. 2B illustrates one exemplary embodiment of touch 240 element of sensing unit 220. A touch zone 210 may operate in conjunction with sensing unit 220 to receive at least one element of touch or tap data. Touch zone 210 can be a pointing device featuring, for example, a tactile sensor, which may be defined as a specialized surface that can translate the motion and position of a user's finger and/or stylus to a relative position on the operating system that is outputted to the screen. Touch zone 210 may operate in one of several ways, including but not limited to, capacitive sensing and conductance sensing. These methods may further include sensing the capacitive virtual ground effect of a touching element (such as a finger or a stylus), or the capacitance between sensors. Capacitance-based touchpads will not sense the tip of a pencil or other similar implement. Gloved fingers may also be problematic. Touch zone 210 may have any of a number of formats, embodiments, or the like. For example, touch zone 210 can be hardware button(s) equivalent to a standard mouse's left and right buttons are positioned below, above, or beside. Further embodiments may have “hotspots”, locations on the touch zone used for functionality beyond a mouse. For example, moving the finger along an edge of the touch pad will act as a scroll wheel, controlling the scrollbar and scrolling the window that has the focus vertically or horizontally. Many touchpads use two-finger dragging for scrolling. Also, some touchpad drivers support tap zones, regions where a tap will execute a function, for example, pausing a media player or launching an application. All of these functions are implemented in the touchpad device driver software, and can be disabled.

Touch 240 element of sensing unit 220 may further comprise stroke detector 242 and stroke analyzer 244. Sensing unit 220 may further comprise a transmitting circuit 236 and broadcasting unit 238, which can additionally allow for sending and/or receiving touch data to and from sensing unit 220. Stroke detector 242 and stroke analyzer 244 operate in a similar function to that described above with reference to audio sensor 232 and speech recognizer 242 in the sense that stroke detector 242 is a sensing element which operates to determine whether a touch has occurred in touchzone 210 so to determine whether or not a user is speaking or writing a data element to the console display terminal. One exemplary process which stroke detector 242 and stroke analyzer 244 use to determine a touch to touchzone 210 and any subsequent “writing” may include a neural network which may be composed of “perceptron” nodes. A perceptron node specifies a weight vector containing n values, where n is the number of inputs to the perceptron. Additionally, it has a “squashing function” g(x) to restrict the range of the output. The perceptron's output when given an input vector x is: Pcpt(\vec{x})=g(\vec{x}·\vec{w})

In one exemplary embodiment, a single perceptron can be trained with examples with known classifications to allow it to output “yes” or “no” for a particular input, where “yes” corresponds to some output range and “no” corresponds to its complement. Twenty-six perceptrons together can each be a “yes”/“no” answerer for each letter. However, instead of interpreting the output as a binary value, the actual output value can be examined and the perceptron with the highest output value can be the winner—that is to say, the letter corresponding to that node is what gets selected. Twenty-six perceptrons alone constitute what is called a single-layer perceptron, and is able to classify problems which are linearly separable in the input space. With a 15-by-12 array of (180) inputs, this means that inputs are points in a 180-dimensional space. For a particular letter, if it is possible to draw a hyperplane in this space to separate all points corresponding to examples of the letter from all points corresponding to examples other letters, then the problem of classifying that letter is linearly separable.

In this exemplary embodiment, this process may be called a “multi-layer perceptron,” or a single layer perceptron whose outputs feed into another single layer perceptron. The layer which accepts inputs and feeds into the output layer is often called the “hidden layer”, and the number of nodes which appear in this layer is a design parameter that can be selected. These types of networks are extremely powerful; they have the ability to fit any function of their inputs, not just linear ones. They can find all sorts of correlations in the input features by seeing lots of examples. They must be trained with an algorithm called back propagation.

The iterated training process allows the network to settle into a state where it minimizes the number of incorrect classifications it makes. With a small training set, though, the network begins to learn features specific to that training set. This is called “overfitting”—the network fails to generalize in this case and doesn't correctly classify anything but those inputs which are extremely close to the training set members. A tradeoff exists between how confidently the network is able to classify and how well it is able to generalize. The correct balance between the two can be found with proper selection of the number of hidden nodes, as well as the duration of training.

Touch 240 element of sensing unit 220 additionally can be in communication with library 250, more specifically stroke recognition dictionary 270 which can optionally further comprise shape 272 and position 274.

Various embodiments described herein may be implemented in a computer-readable medium using, for example, computer software, hardware, or some combination thereof.

For a hardware implementation, the embodiments described herein may be implemented within one or more application specific integrated circuits (ASIGs), digital signal processors (DPs), digital signal processing devices (DSPDs), programmable logic devices (PLD's), field programmable gate arrays (FPGAs), processors, controllers, micro-controllers, microprocessors, other electronic units designed to perform the functions described herein, or a selective combination thereof. Such embodiments may also be implemented by the controller 280.

For a software implementation, the embodiments described herein may be implemented with separate software modules, such as procedures and functions, each of which perform one or more of the functions and operations described herein. The software codes can be implemented with a software application written in any suitable programming language and may be stored in the memory 260, and executed by the controller 280.

FIG. 3 illustrates one embodiment of an environment 300 in which the console display unit may be practiced. Not all the components may be required to practice the invention, and variations in the arrangement and type of the components may be made without departing from the spirit or scope of the invention. As shown in FIG. 3, system 300 includes network 310, wireless network 320, and user entity devices 330, a console display terminal 340 and the user account interface or remote server 350.

Network 310 can be configured to couple user devices 330 and console display terminal 340 with other computing devices, including the user account interface 350, directly to user entity devices 330, directly to console display terminal 340, to and through wireless network 320 to user entity devices 330 and through wireless network 320 to console display terminal 340. Network 310 can be enabled to employ any form of computer readable media for communicating information from one electronic device to another. Also, network 310 can include the Internet in addition to local area networks (LANs) and wide area networks (WANs), direct connections, such as, for example, through a universal serial bus (USB) port, other forms of computer-readable media, or any combination thereof. On an interconnected set of LANs, including those based on differing architectures and protocols, a router acts as a link between LANs, enabling data communication to be sent from one to another. In addition, data communication links within LANs typically include twisted wire pair or coaxial cable, while data communication links between networks may utilize analog telephone lines, full or fractional dedicated digital lines including T1, T2, T3 and T4, Integrated Services Digital Networks (ISDNs), Digital Subscriber Lines (DSLs), wireless links including, but not limited to satellite links, or other communications links known to those skill in the art. Furthermore, remote computers and other related electronic devices could be remotely connected to either LANs or WANs via a modem and temporary telephone link. In essence, network 310 includes any communication method by which information may travel between computing devices.

Wireless network 320 can be configured to couple user entity devices 330 and their components with network 310. Wireless network 320 can included any of a variety of wireless sub-networks that may future overall stand-alone ad-hoc networks, and the like, to provide an infrastructure-oriented connection for user entity devices 330. Such sub-networks may include mesh networks, wireless LAN (WLAN) networks, cellular networks, and any other format of wireless connection.

Wireless network 320 can further include an autonomous system of terminals, gateways, routers, and the like connected by wireless radio links, and similar. These connectors can be configured to move freely and randomly and organize themselves arbitrarily, such that the topology of wireless network 320 may change rapidly.

Wireless network 320 may further employ a plurality of access technologies including second (2G), third (3G) generation radio access for cellular systems, Code Division Multiple Access (CDMA), WLAN, Wireless Router (WR) mesh, and similar configurations. Access technologies such as 2G, 3G and future access network may enable wide area coverage for mobile devices, such as embodiments of user entity devices 330, with various degrees of mobility. For example, wireless network 320 may enable a radio connection through a radio network access such as Global System for Mobil Communication (GSM), General Packet Radio Services (GPRS), Enhanced Data GSM Environment (EDGE), Wideband Code Division Multiple Access (WCDMA), and similar. In essence, wireless network 320 may include virtually any wireless communication mechanism by which information may travel between user entity devices 330 and another computing device, network or similar.

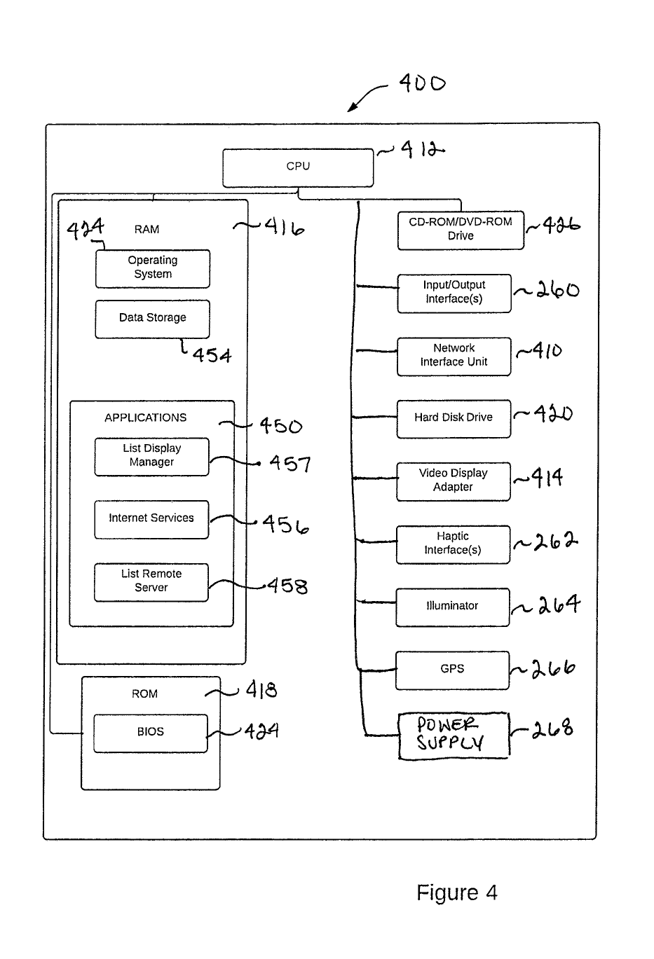

One embodiment of a user entity device 330 is described in more detail below in conjunction with FIG. 4. Generally, however, user entity devices 330 may include virtually any portable computing device capable of receiving and sending data over a network, such as network 310 and wireless network 320. User entity devices 330 may also be described generally as a user entity user device that is configured to be portable. Thus, user entity devices 330 may include virtually any portable computing device capable of connecting to another computing device and receiving information. Such devices include portable devices, for example, mobile phones, smartphones, display pages, Radio Frequency (RF) devices, Infrared (IR) devices, Near Frequency Communication (NFC) devices, Personal Digital Assistants (PDAs), handheld computers, tablets, laptop computers, wearable computers, computer peripheral accessories, integrated devices combining one or more of the preceding devices, and the like. As such, user entity devices 330 typically range widely in terms of capabilities and features. For example, a mobile phone may have a numeric keypad and a few lines of monochromatic LCD display on which only text may be displayed. In another example, a web-enabled mobile device such as a tablet may have a touch sensitive screen, a stylus and several lines of color LCD display in which both text and graphics can be displayed.

User entity devices 330 may include virtually any computing device capable of communicating over a network to send and receive information, including communicating social networking information, performing various online activities, including trading data with other user entity devices, and similar. The set of such devices that can be used for user entity devices 330 include devices that typically connect using wired or wireless communications mediums, such as, for example, personal computers, multiprocessor systems, microprocessor-based or programmable consumer electronics, network PCs, and the like. In one embodiment, at least some of the user entity devices 330 can operate over wired and/or wireless networks. User entity devices 330 can also include virtually device usable as a television device, as many newer models of these devices include a capability to access and/or otherwise communicate over a network such as network 310 and/or wireless network 320. Moreover, user entity devices 330 may access various computing applications, including a browser, social networking interface, and/or any other web-based application.

A web-enabled user entity device 330 may include a browser application that is configured to receive and to send web pages, web-based communications, and any other data. The browser application can be configured to receive and display graphics, text, multimedia, and similar functionalities, employing virtually any web-based language, including, but not limited to, a wireless application protocol (WAP) and similar. In one embodiment, the browser application can be enabled to employ Handheld Device Markup Language (HDML), Wireless Markup Language (WML), WML-Script, JavaScript, Standard Generalized Markup Language (SMGL), Hypertext Markup Language (HTML), extensible Markup Language (XML) and any other programming language that is functionally compatible, to display and send information. In one embodiment, a user of the user entity device 330 can employ the browser to perform various activities over a network; however, another application besides the browser can also be used to perform various online activities.

User entity devices 330 can also include at least one other user entity application that is configured to send and receive content from and to another computing device. The user entity application can include a capability to provide and receive textual content, graphical content, audio content, and any other type of transmittable information. The user entity application can further provide information that identifies itself, including, but not limited to, a type capability, name and any other functionally necessary descriptive information. In one embodiment, user entity devices 330 can uniquely identify themselves through any of a variety of mechanisms, for example, including but not limited to, a phone number, Mobile Identification Number (MIN), an Electronic Serial Number (ESN), a Global Positioning System (GPS) identifies, or other mobile device identifier. In additional embodiments, the information can also indicate a content format that the mobile device is enabled to employ. For example, such information can be provided in a network packet, or any other data transmission format, sent the user account interface 350, or any other interface. Such end-user account, for example, can be configured to enable the end-user to manage one or more online activities, including, for example, but not limited to, search activities, browsing of various websites, making purchases, selling products/services, communicating with others and otherwise engaging in online activities. However, participation in such online activities can also be performed without logging into an end-user account.

As described in FIGS. 1-2, console display terminal 340 may include computing, processing and/or transceiving elements which are capable of receiving communications and communication media over a network, including receiving data item information, performing various online activities, including receiving data from other user entity devices, user entity peripherals and similar.

Communication media typically embodies computer-readable instructions, data structures, program modules, or other transport mechanism and includes any information delivery media. By way of example, and not in limitation, communication media can include wired media such as twisted pair, coaxial cable, fiber optics, wave guides, and other wired media and wireless media such as acoustic, Radio Frequency (RF), Near Frequency Communication (NFC), infrared, and other wireless media.

One embodiment of user account interface 350 is described in more detail below in conjunction with FIG. 5. Briefly, user account interface 350 may include any one or more computing device, server and/or remote server capable of connecting to network 310 to enable user entity devices 330 to communicate between each other. In one embodiment, user account interface 350 can further enable one or more users of user entity devices 330 to access and/or download a user account interface application (not shown) for use on the user entity devices 330. In one embodiment, the user account interface application is configured to enable a user entity to provide data items as described above and delivery and/or sync settings.

As described in FIGS. 1-2, console display terminal 340 may include computing, processing and/or transceiving elements which are capable of receiving communications and communication media over a network, including receiving data item information, performing various online activities, including receiving data from other user entity devices, user entity peripherals and similar.

Communication media typically embodies computer-readable instructions, data structures, program modules, or other transport mechanism and includes any information delivery media. By way of example, and not in limitation, communication media can include wired media such as twisted pair, coaxial cable, fiber optics, wave guides, and other wired media and wireless media such as acoustic, Radio Frequency (RF), Near Frequency Communication (NFC), infrared, and other wireless media.

FIG. 4 shows one embodiment of a network device 400 according to one embodiment of the invention, which is capable of, for example, downloading computer executable instructions for operation of a console display terminal, creating a user account to sync with and function as a component of console display terminal, and/or operating independently execute computer readable instructions for an application to mimic functionality of a console display unit. Network device 400 may include many more or less components than those shown. The components shown, however, are sufficient to disclose an illustrative embodiment for practicing the invention. Network device 400 may represent, for example, user account interface or remote server 350 of FIG. 3.

Network device 400 includes processing unit 412, display adapter 414, and a mass memory. This mass memory generally includes RAM 416, ROM 418, and one or more permanent mass storage devices, such as hard disk drive 420, tape drive, optical drive, and/or floppy disk drive. The mass memory stores operating system 424 for controlling the operation of network device 400. Any general-purpose operating system may be employed. Basic input/output system (“BIOS”) 424 is also provided for controlling the low-level operation of network device 400.

As illustrated in FIG. 4, network device 400 can also communicate with the Internet, or some other communication protocols including the TCP/IP protocol. Network interface unit 410 is sometimes known as a transceiver, transceiving device, or network interface card (NIC).

The mass memory as described above illustrates another type of computer-readable storage devices, namely computer-readable storage media or devices. Computer-readable storage media may include volatile, nonvolatile, removable, and non-removable devices implemented in any method or technology for storage of information, such as computer readable instructions, data structures, program modules, or other data. Examples of computer readable storage media include RAM 416, ROM 418, EEPROM, flash memory or other memory technology, CD-ROM, digital versatile disks (DVD) 426 or other optical storage, magnetic cassettes, magnetic tape, magnetic disk storage or other magnetic storage devices, or any other physical medium which can be used to store the desired information and which can be accessed by a computing device.

As shown, data stores 454 may include a database, text, spreadsheet, folder file, or the like, that may be configured to maintain and store user account identifiers, user profiles, data item remote locations, and/or other network addresses; or the like. Data stores 454 may also store various data item syncing content, and/or information about network communication, including, but not limited to content and data sync sender and receiver information, duration of user sessions, a quantity of content indexed and catalogued between users and/or locations, and/or data obtained from conducting a content analysis. In on embodiment, storage of such information may be based on a specific user, user account, profile, or the like. Thus, in one embodiment, storage of the information may be configured to provide at least some security and/or privacy constraints on the information. Data stores 454 may further include program code, data, algorithms, and the like, for use by a processor, such as central processing unit (CPU) 412 to execute and perform actions. In one embodiment, at least some of data store 454 might also be stored on another component of network device 400, including, but not limited to cd-rom/dvd rom 426, hard disk drive 420, or the like.

The mass memory also stores program code and data. One or more applications 450 are loaded into mass memory and run on operating system 422. Examples of application programs may include transcoders, schedulers, calendars, data-base programs, word processing programs, HTTP programs, customizable user interface programs, IPSec applications, encryption programs, security programs, SMS message servers, IM message servers, email servers, account managers, and so forth. List Display Manager 457, Internet services 456, and List Remote Server 458, may also be included as application programs within applications 450.

List Display Manager 457 represent any of a variety of services that are configured to provide content, including lists and data items, over a network to another computing device. Thus, List Display Manager 457 includes for example, a web server, a File Transfer Protocol (FTP) server, a database server, a content server, or the like. List Display Manager 457 may provide the content including messages over the network using any of a variety of formats, including, but not limited to WAP, HDML, WML, SMGL, HTML, XML, cHTML, XHTML, or the like.

Internet server 456 may include virtually any computing component or components configured and arranged to forward messages and content from content and message user agents, and/or other content and message servers, or to deliver content messages to a local content and message store, such as data store 454, or the like. Thus, Internet server 456 may include a content and message transfer manager to communicate a message employing any of a variety of email protocols, including, but not limited, to Simple Mail Transfer Protocol (SMTP), Post Office Protocol (POP), Internet Message Access Protocol (IMAP), MNTP, or the like. Internet server 456 may also be managed by one or more components of Internet server 456. Thus, Internet server 456 may also be configured to manage SMS messages, IM, MMS, IRC, RSS feeds, mIRC, or any of a variety of other message types. In one embodiment, Internet server 456 may enable users to initiate and/or otherwise conduct chat sessions, VOIP sessions, or the like.

In one embodiment, List Display Manager 457 is configured to provide a downloadable component, such as to a client device for use in managing data item(s), and/or managing list(s), and/or the like. In one embodiment, List Display Manager 457 might operate independent of a local List Display Manager of a client device. That is, in one embodiment, a client device might be configured to interact with List Remote Server 458 and/or internet services 456, which in turn interact with List Display Manager 457 to provide data items and/or list action(s) to a client device.

FIG. 5 illustrates one exemplary method 500 for using one embodiment of a console display terminal. Method 500 begins at 502, and at 504 a user enters at least one data item.

At 506, the at least one data item is detected. Detection may occur through any series of reasonably known or reasonably ascertainable detection methods, many of which are described herein in relation to FIGS. 1-4. For example, detection may occur through sensors such as transducers and/or transceivers, or any other functionally feasible detection elements and/or modules.

At 508, a processor or other information and/or computational module or element of the console display terminal operates a decision if the detected one data item is an audio data item.

If the detected data item is determined at 508 to be an audio data item, the audio data item is analyzed at 510.

After analysis, the audio data item is displayed as characters at 512.

If the detected data is not determined at 508 to be an audio data item, a touch data item is analyzed at 514.

After this analysis, the touch data item is displayed as characters at 518.

Additional embodiments contemplate wherein the at least one data item may be a combination of audio data and touch data, therefore, in these embodiments the determination at 508 may result in a simultaneous decision that the data item contains both audio data and touch data, and therefore analysis at 510 and 514 may occur simultaneously, as well as display at 512, 514 may additionally occur simultaneously and result single, congruous display of the data item as characters irrespective of the origin type of the at least one data item at 506.

At 518, the data can thereafter be configured for transmission out of the console display termination, and thereafter transmitted at 520 via a transceiver or similar computing module.

At 522, data items may likewise be received by the console display terminal from other network devices via the transceiver or similar computing module. A further aspect of receiving content from other network devices can optionally include authentication and review of privacy-publicity settings for devices from which data is transmitted to the console display terminal. Authentication of user entities and their user entity devices can occur through various methods and embodiments as contemplated to be used alone, in conjunction or integrated into the system, methods, and processes which are part of this inventive concept.

Authentication can be defined as the act of confirming the truth of an attribute of a datum or entity. This might involve confirming the identity of a person or software program, tracing the origins of an artifact, or ensuring that a product is what it's packaging and labeling claims to be. Authentication often involves verifying the validity of at least one form of identification.

In one embodiment, a secure key storage device can be used for authentication in consumer electronics, network authentication, license management, supply chain management, and any other system or process that requires an authentication element. Generally, for example, the device to be authenticated can have some sort of wireless or wired digital connection to either a host system or a network. The component being authenticated need not be electronic in nature as an authentication chip can be mechanically attached and read through a connector to the host e.g. an authenticated ink tank for use with a printer. For products and services that these secure coprocessors can be applied to, they can offer a solution that can be much more difficult to counterfeit than most other options while at the same time being more easily verified.

The process of authorization is distinct from that of authentication. Whereas authentication is the process of verifying that “you are who you say you are”, authorization is the process of verifying that “you are permitted to do what you are trying to do”. Authorization thus presupposes authentication. For example, a client showing proper identification credentials to a bank teller is asking to be authenticated that he really is the one whose identification he is showing. A client whose authentication request is approved becomes authorized to access the accounts of that account holder, but no others. However note that if a stranger tries to access someone else's account with his own identification credentials, the stranger's identification credentials will still be successfully authenticated because they are genuine and not counterfeit, however the stranger will not be successfully authorized to access the account, as the stranger's identification credentials had not been previously set to be eligible to access the account, even if valid (i.e. authentic).

Similarly when someone tries to log on a computer, they are usually first requested to identify themselves with a login name and support that with a password. Afterwards, this combination is checked against an existing login-password validity record to check if the combination is authentic. If so, the user becomes authenticated (i.e. the identification he supplied in step 1 is valid, or authentic). Finally, a set of pre-defined permissions and restrictions for that particular login name is assigned to this user, which completes the final step, authorization. Even though authorization cannot occur without authentication, the former term is sometimes used to mean the combination of both.

One exemplary use of authentication and authorization is access control. In one embodiment of the present process, a user entity device is contemplated to be used only by those authorized, and attempts to detect and exclude the unauthorized are considered. Access to a user entity device should then, generally, be controlled by insisting on an authentication procedure to establish with some degree of confidence the identity of the user, granting privileges established for that identity. Further exemplary examples of access control involving authentication include, but are not limited to, using a captcha or other recognition software application as a means of asserting that a user is a human being and not a computer program, by using One Time Password (OTP), received on a tele-network enabled device like mobile phone, as an authentication password/PIN, A computer program using a blind credential to authenticate to another program, using a confirmation E-mail to verify ownership of an e-mail address.

In additional exemplary embodiments of the present process, ease of access may be balanced against the strictness of access checks. In one example, a credit card network infrastructure may be modeled but where the system does or does not require a personal identification number for authentication of the claimed identity.

At 524, the received data is displayed and the method thereafter ends at 526.

Additional methods, aspects and elements of the present inventive concept are contemplated in use in conjunction with individually or in any combination thereof which will create a reasonably function device to be of use as a grabbing apparatus to removably connect to a docking location. Methods of use are also contemplated using all optional aspects and embodiments as described above, individually or in combination thereof.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement and components shown and described above, but may be susceptible to numerous variations within the scope of the invention.

Moreover, particular exemplary features described herein in conjunction with specific embodiments and/or aspects of the present invention are to be construed as applicable to any embodiment described within, enabled thereby, or apparent wherefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptations, and the same are intended to be comprehended within the meaning and range of equivalents of the appended claims.

Therefore, I claim:

1. A console display terminal, comprising:
a display screen configured to display at least one data item entered by a user;
a transceiver configured to send and receive the at least one data item to at least one network device;
a sensing unit configured to detect and analyze an entry of the at least one data item entered by the user; and
a controller configured to verify the detected entry of the at least one data item;
wherein the controller, upon detection and analysis of the at least one data item by the sensing unit, verifies the detected entry by evaluating the detected entry and identifying a display form for the at least one data item; and wherein the controller authorizes the display screen to display the at least one data item in the determined display form in a list and authorizes the transceiver to send the at least one data item to the at least one network device.

2. The console display terminal of claim 1, wherein the sensing unit further comprises:
an input surface further comprising a touch zone, wherein the touch zone is configured to capture at least one stroke made by the user on the input surface;
a stroke dictionary containing a plurality of characters stored based on shape and position; and
a stroke recognizer configured to identify the at least one stroke as a character of the plurality of characters upon comparison to stroke dictionary storage.

3. The console display terminal of claim 1, wherein the sensing unit further comprises:
an audio detector which is configured to detect at least one audio tone created by a user;
a speech recognition dictionary containing a plurality of audio tones stored as at least one word based on a sound and a phonetic construction; and
a speech recognizer configured to identify the at least one audio tone as at least one word from the speech recognition dictionary.

4. The console display terminal of claim 1, wherein identifying the display form by the controller further comprises:
determining an order of detection of the at least one data item;
ordering the at least one data item according to a predetermined list feature based on the order of detection; and
authorizing the display screen to display the at least one data item based on the predetermined list feature.

5. The console display terminal of claim 4, wherein the predetermined list feature further comprises:
a user option to select the parameters of the predetermined list feature; and
a user option to create more than one predetermined list features.

6. The console display terminal of claim 5, wherein the predetermined list feature further comprises:
a memory for storing the at one or more predetermined list features; and
a memory for storing the one or more display forms created based on user entry of the at least one data item.

7. The console display terminal of claim 1, wherein the display screen further comprises a check box element which can be selected and de-selected based on the at least one data item displayed.

8. The console display terminal of claim 1, wherein the transceiver is further configured to authenticate, send and receive the at least one data item between the display console device and a plurality of network devices.

9. The console display terminal of claim 1, further comprising a replaceable independent power source.

10. A system comprising:
an intermediate computing device in communication via a network with one or more user devices and a console display terminal;
wherein said console display terminal comprises a processor that is configured to communicate with the intermediate computing device and the one or more client devices via the network, said console display terminal further configured to perform actions comprising:
detecting the at least one data item entered by a user;
verifying and analyzing the at least one data item entered by the user;
identifying a display form for the at least one data item;
displaying the at least one data item in the determined display form in a list;
configuring the at least one data item such that it is transmittable to the intermediate computing device and the one or more user devices via the network; and
sending and receiving the at least one data item to and from the intermediate computing device, the one or more user devices, and the console display terminal via the network.

11. The system of claim 10, wherein detecting the at least one data item entered by a user further comprises:
sensing at least one stroke made by the user on an input surface of the console display terminal;
comparing the at least one stroke to a stroke dictionary containing a plurality of characters stored based on shape and position; and
identifying the at least one stroke as a character of the plurality of characters upon comparison to the stroke dictionary.

12. The system of claim 10, wherein detecting the at least one data item entered by a user further comprises:
detecting at least one audio tone created by the user;
comparing the at least one audio tone to a speech recognition dictionary containing a plurality of audio tones stored as at least one word based on a sound and a phonetic construction; and
identifying the at least one audio tone as at least one word from the speech recognition dictionary.

13. The system of claim 10, wherein configuring the at least one data item further comprises:
configuring the at least one data item as one of a plurality of data items contained in the display form; and
transmitting the at least one data item as one of a plurality of data items contained in the display form to and from the intermediate computing device, the one or more user devices, and the console display terminal via the network.

14. The system of claim 10, wherein sending and receiving the at least one data item to and from the intermediate computing device, the one or more user devices, and the console display terminal via the network further comprises:
a transceiver configured to communicate wirelessly using at least one radio frequency, said transceiver configured to send and receive the at least one data item according to IEEE 802.11 a, b, g, 2007, n, 2012, ac, ad, of and ah protocols and IEEE 802.15.1 protocols.

15. The system of claim 10, wherein sending and receiving the at least one data item to and from the intermediate computing device, the one or more user devices, and the console display terminal via the network further comprises:
a transceiver configured to communicate wirelessly using at least one infrared frequency, said transceiver configured to send and receive the at least one data item according to IrDA-SIR, IrDA-MIR, and IrDA-FIR protocols.

16. The system of claim 10, wherein sending and receiving the at least one data item to and from the intermediate computing device, the one or more user devices, and the console display terminal via the network further comprises:
A transceiver configured to authenticate wirelessly, comprising:
encrypting the at least one data item when entered by the user;
initiating wireless communication with a wireless communication device authenticating the wireless communication device using a private authentication key to authenticate the user's identity, identify the originating source of the at least one data item, and authenticate a stored data transmitted with the at least one data item; and
sending the encrypted at least one data item upon positive authentication of the wireless communication device.

17. The system of claim 10, wherein verifying and analyzing the at least one data item entered by the user further comprises comparing the entered at least one data item to a matrices of stored data libraries, wherein the matrices of stored data libraries further comprise audio tones and written stroke characters stored so that all information is accessible to the controller at such time that the user enters the at least one data item.

18. The system of claim 10, wherein configuring the at least one data item such that it is transmittable to the intermediate computing device and the one or more user devices via the network further comprises storing the at least one data item to a memory in console display terminal.

19. The system of claim 10, wherein sending and receiving the at least one data item to and from the intermediate computing device, the one or more user devices, and the console display terminal via the network further comprises transmitting a communication with the transmitted at least one data item that is displayed on the one or more user devices as a coupon based on collected geographic data of the one or more user devices.

20. A non-transitory computer readable storage medium having computer executable instructions, the computer executable instructions when installed onto a computing device enable the computing device to perform actions, comprising:
detecting the at least one data item entered by a user;
verifying and analyzing the at least one data item entered by the user;
identifying a display form for the at least one data item;
displaying the at least one data item in the determined display form in a list;
configuring the at least one data item such that it is transmittable to the intermediate computing device and the one or more user devices via the network; and
sending and receiving the at least one data item to and from the intermediate computing device, the one or more user devices, and the console display terminal via the network.

21. The non-transitory computer readable storage medium having computer executable instructions, the computer executable instructions of claim 20, enabling the computing device to perform actions, wherein detecting the at least one data item entered by a user further comprises:
sensing at least one stroke made by the user on an input surface of the console display terminal;
comparing the at least one stroke to a stroke dictionary containing a plurality of characters stored based on shape and position; and
identifying the at least one stroke as a character of the plurality of characters upon comparison to the stroke dictionary.

22. The non-transitory computer readable storage medium having computer executable instructions, the computer executable instructions of claim 20, enabling the computing device to perform actions, wherein detecting the at least one data item entered by a user further comprises:
detecting at least one audio tone created by the user;
comparing the at least one audio tone to a speech recognition dictionary containing a plurality of audio tones stored as at least one word based on a sound and a phonetic construction; and
identifying the at least one audio tone as at least one word from the speech recognition dictionary.

23. The non-transitory computer readable storage medium having computer executable instructions, the computer executable instructions of claim 20, enabling the computing device to perform actions, wherein configuring the at least one data item further comprises:
configuring the at least one data item as one of a plurality of data items contained in the display form; and
transmitting the at least one data item as one of a plurality of data items contained in the display form to and from the intermediate computing device, the one or more user devices, and the console display terminal via the network.

24. The non-transitory computer readable storage medium having computer executable instructions, the computer executable instructions of claim 20, enabling the computing device to perform actions, wherein sending and receiving the at least one data item to and from the intermediate computing device, the one or more user devices, and the console display terminal via the network further comprises:
a transceiver configured to communicate wirelessly using at least one radio frequency, said transceiver configured to send and receive the at least one data item according to IEEE 802.11 a, b, g, 2007, n, 2012, ac, ad, of and ah protocols and IEEE 802.15.1 protocols.

25. The non-transitory computer readable storage medium having computer executable instructions, the computer executable instructions of claim 20, enabling the computing device to perform actions, wherein sending and receiving the at least one data item to and from the intermediate computing device, the one or more user devices, and the console display terminal via the network further comprises:
a transceiver configured to communicate wirelessly using at least one infrared frequency, said transceiver configured to send and receive the at least one data item according to IrDA-SIR, IrDA-MIR, and IrDA-FIR protocols.

26. The non-transitory computer readable storage medium having computer executable instructions, the computer executable instructions of claim 20, enabling the computing device to perform actions, wherein sending and receiving the at least one data item to and from the intermediate computing device, the one or more user devices, and the console display terminal via the network further comprises:
a transceiver configured to authenticate wirelessly, comprising:
encrypting the at least one data item when entered by the user;
initiating wireless communication with a wireless communication device
authenticating the wireless communication device using a private authentication key to authenticate the user's identity, identify the originating source of the at least one data item, and authenticate a stored data transmitted with the at least one data item; and
sending the encrypted at least one data item upon positive authentication of the wireless communication device.

27. The non-transitory computer readable storage medium having computer executable instructions, the computer executable instructions of claim 20, enabling the computing device to perform actions, wherein verifying and analyzing the at least one data item entered by the user further comprises comparing the entered at least one data item to a matrices of stored data libraries, wherein the matrices of stored data libraries further comprise audio tones and written stroke characters stored so that all information is accessible to the controller at such time that the user enters the at least one data item.

28. The non-transitory computer readable storage medium having computer executable instructions, the computer executable instructions of claim 20, enabling the computing device to perform actions, wherein configuring the at least one data item such that it is transmittable to the intermediate computing device and the one or more user devices via the network further comprises storing the at least one data item to a memory in console display terminal.

29. The non-transitory computer readable storage medium having computer executable instructions, the computer executable instructions of claim 20, enabling the computing device to perform actions, wherein sending and receiving the at least one data item to and from the intermediate computing device, the one or more user devices, and the console display terminal via the network further comprises transmitting a communication with the transmitted at least one data item that is displayed on the one or more user devices as a coupon based on collected geographic data of the one or more user devices.
